(19) United States
(12) Patent Application Publication
(10) Pub. No.: US 2026/0302703 A1
(43) Pub. Date: Oct. 1, 2026

(54) CONDUCTIVE QUICK CONNECTOR STRUCTURE

(71) Applicant: Zhongshan Huoshan Lighting Co., Ltd., Zhongshan (CN)

(72) Inventor: Bo GOU, Zhongshan (CN)

(73) Assignee: Zhongshan Huoshan Lighting Co., Ltd., Zhongshan (CN)

(21) Appl. No.: 19/630,514

(22) Filed: Mar. 27, 2026

(30) Foreign Application Priority Data
Mar. 28, 2025 (CN) 2025205778198

(51) Int. Cl. H01R 31/02; H01R 13/424; H01R 13/50; H01R 13/506; H01R 13/52; H01R 103/00

(52) U.S. Cl. CPC H01R 31/02; H01R 13/424; H01R 13/50; H01R 13/506; H01R 13/52; H01R 2103/00

(57) ABSTRACT

Disclosed in this disclosure is a conductive quick connector structure. At least two quick connecting channels are integrally formed in a quick connector housing. An insertion structure provided with an insertion connector in an inserting manner and a positioning column provided with positive and negative conductive components in a sleeving manner are disposed on an intersection region formed by the channel. A window is formed on an end surface of the housing for mounting the insertion connector, and the window is equipped with a window cover. Various components are mounted through the window, and the housing is connected to the window cover through a quick mounting structure. Welding is not needed, mounting is convenient, assembly efficiency is high, connection is stable, and waterproof grade is ensured.

### CROSS-REFERENCE TO RELATED APPLICATIONS

The application claims priority to Chinese patent application No. 2025205778198, filed on Mar. 28, 2025, the entire contents of which are incorporated herein by reference.

### TECHNICAL FIELD

This disclosure relates to the technical field of conductive quick connections, and in particular, to a conductive quick connector structure.

### BACKGROUND

In some expandable lamps, connectors with a plurality of connecting ports are typically used to connect a plurality of lamps. However, in these expandable lamps, the connectors thereof only serve a connecting function, and voltage transmission between lamps still relies on wires. The wires pass through the connectors, resulting in the problem of cumbersome mounting of wires.

To address the problems of physical and electrical quick connections in lamp expansion, products such as lamp connectors and conductive connectors have been introduced. These technologies are disclosed in patents with publication numbers CN212005585U and CN214370043U.

As shown in the above two patents, existing connectors and connecting bodies of connecting members are divided into a lower U-shaped groove and an upper U-shaped cover, which are connected by mating the lower U-shaped groove and the upper U-shaped cover up and down. During actual operations, it is found that using ultrasonic welding to fixedly connect the lower U-shaped groove to the upper U-shaped cover is an extremely cumbersome operation that presents significant welding difficulties. Furthermore, gaps are prone to emergence after welding is complete. This not only affects the connection stability between the lower U-shaped groove and the upper U-shaped cover but also is prone to water seepage, thereby affecting the waterproof grade of the connecting members.

This disclosure provides new technical solutions under this background.

### SUMMARY

This disclosure aims to at least solve one of the technical problems existing in the prior art. Therefore, this disclosure provides a conductive quick connector structure, adopting the following technical solution:

A conductive quick connector structure, including a quick connector body, where the quick connector body includes a quick connector housing, at least two quick connecting channels are integrally formed in the quick connector housing, all the quick connecting channels intersect within the quick connector housing to form an intersection region, an insertion structure for inserting an insertion connector is integrally formed on one side of the intersection region facing each quick connecting channel, and a positioning column for sleeving a positive conductive component and a negative conductive component is integrally formed in the intersection region; a window is formed on an end surface on one side of the quick connector housing perpendicular to the positioning column, and the window exposes at least a part of the quick connecting channel to sleeve the insertion connector into the quick connecting channel from the outside to the inside; and a window cover covers the window.

According to the conductive quick connector structure of an embodiment of this disclosure, a plurality of insertion connectors are further included, and a number of the insertion connectors is consistent with a number of the quick connecting channels.

According to the conductive quick connector structure of an embodiment of this disclosure, a limiting block is disposed at an end portion on an inner side of the insertion connector, the insertion structure is an insertion slot, and the limiting block is inserted into the insertion slot through the window from the outside to the inside.

According to the conductive quick connector structure of an embodiment of this disclosure, a limiting slot is formed at an end portion on an inner side of the insertion connector, the insertion structure is an insertion block, and the limiting slot is inserted into the insertion block through the window from the outside to the inside.

According to the conductive quick connector structure of an embodiment of this disclosure, the positive conductive component and the negative conductive component are further included, the positive conductive component includes a plurality of positive conductive heads, the negative conductive component includes a plurality of negative conductive heads, a number of the positive conductive heads is consistent with that of the negative conductive heads, the number is consistent with the number of the insertion connectors, and at least the positive conductive head and the negative conductive head are disposed in each insertion connector.

According to the conductive quick connector structure of an embodiment of this disclosure, a plurality of positive conductive slots and negative conductive slots are formed in the insertion connectors, the negative conductive heads are inserted into the negative conductive slots, and the positive conductive heads are inserted into the positive conductive slots.

According to the conductive quick connector structure of an embodiment of this disclosure, a positioning sleeve is disposed on each of the positive conductive component and the negative conductive component, and the positioning sleeve is sleeved on the positioning column.

According to the conductive quick connector structure of an embodiment of this disclosure, a snap structure for connecting the quick connector housing and the window cover in a snap manner is formed between the end surface of the quick connector housing at an outer edge of the window and the window cover.

According to the conductive quick connector structure of an embodiment of this disclosure, the quick connecting channels are quick connecting slots integrally formed in the quick connector housing, and a quick connecting port is formed at one outward end of each quick connecting slot.

According to the conductive quick connector structure of an embodiment of this disclosure, there are two, three, or four quick connecting slots and quick connecting ports, and a shape of the quick connector housing includes a linear structure, a right-angled structure, a three-way structure, or a cross-shaped structure.

Compared with the prior art, the beneficial effects of this disclosure are as follows:

In this disclosure, the quick connecting channels, the insertion structures, and the positioning column are all integrally formed in the quick connector housing. The insertion connectors, the positive conductive component, and the negative conductive component are all mounted in the quick connector housing through the window formed on one side of the quick connector housing. The quick connector housing and the window cover do not need to be welded and can be bonded, buckled, or snapped through a quick mounting structure. The connection stability is ensured, and the mounting is convenient and fast, greatly improving the assembly efficiency and ensuring the waterproof grade.

### BRIEF DESCRIPTION OF THE DRAWINGS

The above and/or additional aspects and advantages of this disclosure will become apparent and easy to understand from the description of the embodiments in conjunction with the following accompanying drawings, where:

FIG. 1 is a schematic three-dimensional diagram 1 of Embodiment 1 according to this disclosure;

FIG. 2 is a schematic three-dimensional diagram 2 of Embodiment 1 according to this disclosure;

FIG. 3 is a schematic exploded view 1 of Embodiment 1 according to this disclosure;

FIG. 4 is a schematic exploded view 2 of Embodiment 1 according to this disclosure;

FIG. 5 is a schematic exploded view 3 of Embodiment 1 according to this disclosure;

FIG. 6 is a schematic three-dimensional diagram of Embodiment 2 according to this disclosure;

FIG. 7 is a schematic three-dimensional diagram of Embodiment 3 according to this disclosure;

FIG. 8 is a schematic three-dimensional diagram of Embodiment 4 according to this disclosure;

FIG. 9 is a schematic three-dimensional diagram of Embodiment 5 according to this disclosure; and

FIG. 10 is a schematic three-dimensional diagram of Embodiment 6 according to this disclosure.

Reference numerals of main elements are as follows:
10. quick connector housing; 11. insertion slot; 12. step; 13. snap hole; 20. positioning column; 30. window; 40. quick connecting slot; 50. insertion connector; 51. limiting block; 52. positive conductive slot; 53. negative conductive slot; 60. window cover; 61. snap column; 70. positive conductive component; 71. positive conductive head; 80. negative conductive component; 81. negative conductive head; 90. positioning sleeve.

### DETAILED DESCRIPTION OF THE EMBODIMENTS

The embodiments of this disclosure are described in detail below and examples of the embodiments are shown in the accompanying drawings, where the same or similar reference numerals always represent the same or similar elements or elements with the same or similar functions.

The orientations shown in the accompanying drawings should not be construed as limiting the specific scope of protection of this disclosure, but merely serve as a reference for understanding the preferred embodiments. The product components shown in the drawings may undergo changes in position, increases in quantity, or structural simplifications.

The “connection” described in the specification and the mutual “connection” relationships between the components shown in the accompanying drawings may be understood as a fixed connection, a detachable connection, or an integral connection; and it may be a direct connection or a connection through an intermediate medium. Those of ordinary skill in the art may interpret these connection relationships based on specific situations to determine that various manners such as screwing, riveting, welding, snapping, or embedding may be suitably substituted across different embodiments.

The directional terms such as “upper”, “lower”, “left”, “right”, “top”, and “bottom” described in the specification and the orientations shown in the accompanying drawings indicate that various components may be in direct contact with each other or may be in contact with each other through other features therebetween. For example, “above” may be “directly above” or “diagonally above”, or it may simply indicate “higher than another object”; and other orientations may also be interpreted analogously.

The manufacturing materials for solid-shaped components represented in the specification and accompanying drawings may adopt metallic materials, non-metallic materials, or other synthetic materials. The mechanical processing processes employed for any such solid-shaped components may include stamping, forging, wire cutting, laser cutting, casting, injection molding, CNC milling, 3D printing, general machining, and the like. Those of ordinary skill in the art may perform adaptive selection or combined selection, which is not limited to the above materials and manufacturing processes, according to different processing conditions, costs, and accuracy.

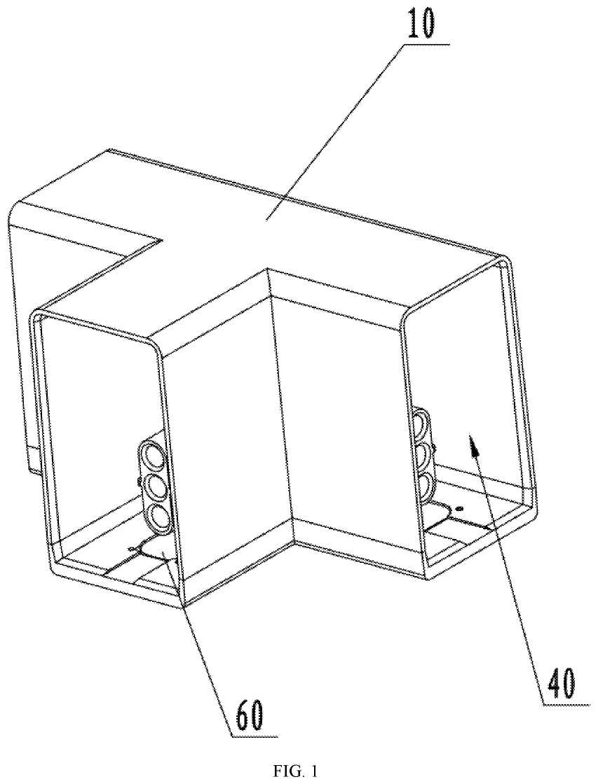

This disclosure provides a conductive quick connector structure, as shown in Embodiment 1 in FIG. 1 to FIG. 5, including a quick connector body. The quick connector body includes a quick connector housing 10. Three quick connecting channels are integrally formed in the quick connector housing 10. All the quick connecting channels intersect within the quick connector housing 10 to form an intersection region. An insertion structure for inserting an insertion connector 50 is integrally formed on one side of the intersection region facing each quick connecting channel. A positioning column 20 for sleeving a positive conductive component 70 and a negative conductive component 80 is integrally formed in the intersection region. A window 30 is formed on an end surface on one side of the quick connector housing 10 perpendicular to the positioning column 20, and the window 30 exposes at least a part of the quick connecting channel to sleeve the insertion connector 50 into the quick connecting channel from the outside to the inside. A window cover 60 covers the window 30.

Further, as shown in Embodiment 1 to Embodiment 6 in FIG. 1 to FIG. 10, the quick connecting channels are quick connecting slots 40 integrally formed in the quick connector housing 10, and a quick connecting port is formed at one outward end of each quick connecting slot 40.

As shown in Embodiment 1 in FIG. 1 to FIG. 5, there are three quick connecting slots 40 and quick connecting ports. The quick connector housing 10 is of a T-shaped three-way structure, which also has three quick connecting channels.

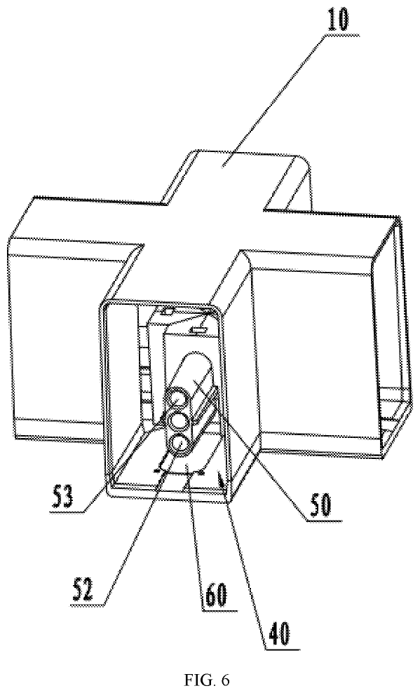

As shown in Embodiment 2 in FIG. 6, there are four quick connecting slots 40 and quick connecting ports. The quick connector housing 10 is of a cross-shaped structure, which also has four quick connecting channels.

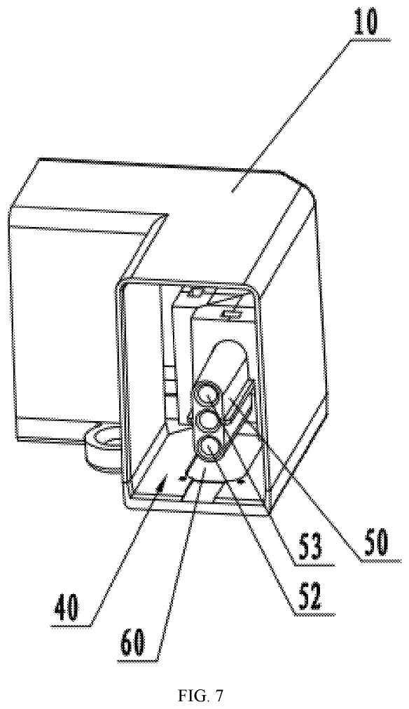

As shown in Embodiment 3 in FIG. 7, there are two quick connecting slots 40 and quick connecting ports. The quick connector housing 10 is of a right-angled structure, which also has two quick connecting channels.

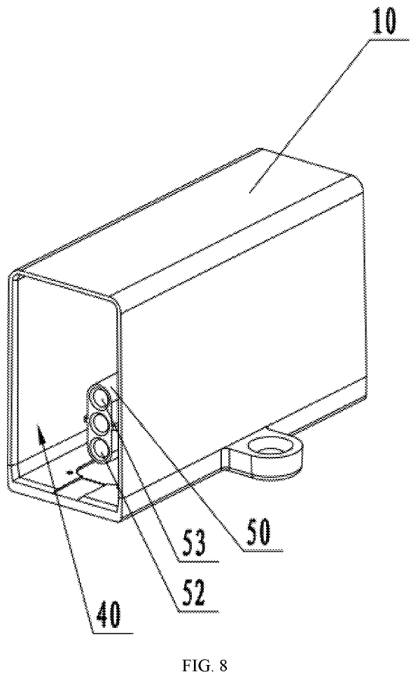

As shown in Embodiment 4 in FIG. 8, there are two quick connecting slots 40 and quick connecting ports. The quick connector housing 10 is of a linear structure, which also has two quick connecting channels.

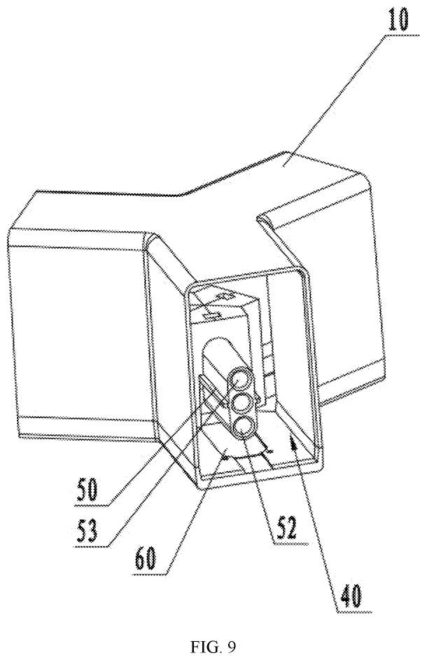

As shown in Embodiment 5 in FIG. 9, there are three quick connecting slots 40 and quick connecting ports. The quick connector housing 10 is of a forked three-way structure, which also has three quick connecting channels.

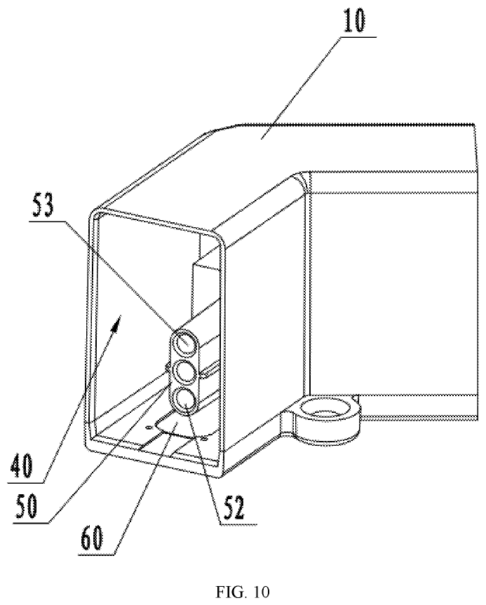

As shown in Embodiment 6 in FIG. 10, there are two quick connecting slots 40 and quick connecting ports. The quick connector housing 10 is of a bending two-way structure, which also has two quick connecting channels, and an included angle of 120° is formed between the two quick connecting channels.

Certainly, the quick connector housing 10 may be of other shapes, and the number of the quick connecting channels, the quick connecting slots 40, and the quick connecting ports is also determined according to different shapes.

As shown in Embodiment 1 to Embodiment 6 in FIG. 1 to FIG. 10, the conductive quick connector structure of this patent further includes a plurality of insertion connectors 50, and the number of the insertion connectors 50 is consistent with the number of the quick connecting channels.

The positive conductive component 70 and the negative conductive component 80 are included. The positive conductive component 70 includes a plurality of positive conductive heads 71, and the negative conductive component 80 includes a plurality of negative conductive heads 81. The number of the positive conductive heads 71 is consistent with that of the negative conductive heads 81, and the number is consistent with the number of the insertion connectors 50. At least the positive conductive head 71 and the negative conductive head 81 are disposed in each insertion connector 50. A positioning sleeve 90 is disposed on each of the positive conductive component 70 and the negative conductive component 80, and the positioning sleeve 90 is sleeved on the positioning column 20.

During mounting, first, the plurality of negative conductive heads 81 of the negative conductive component 80 are mounted on different insertion connectors 50 respectively; then, the plurality of positive conductive heads 71 of the positive conductive component 70 are mounted on different insertion connectors 50 respectively; then, the positioning sleeve 90 is aligned with the positioning column 20, and the insertion connectors 50 are aligned with the insertion structures on the side portions of the intersection region; and then, the insertion connectors 50 with the positive conductive component 70 and the negative conductive component 80 are inserted into the quick connector housing 10 through the window 30 from the outside to the inside. After the insertion is completed, the positioning sleeve 90 is sleeved on the positioning column 20, the insertion connectors 50 are inserted into the insertion structures, and the insertion connectors 50 are placed in the quick connecting channels. Finally, after all the components are confirmed to be mounted in place, the window cover 60 then tightly covers the window 30.

In this disclosure, the quick connecting channels, the insertion structures, and the positioning column 20 are all integrally formed in the quick connector housing 10. The insertion connectors 50, the positive conductive component 70, and the negative conductive component 80 are mounted in the quick connector housing 10 through the window 30 formed on one side of the quick connector housing 10. The quick connector housing 10 and the window cover 60 do not need to be welded and can be bonded, buckled, or snapped through a quick mounting structure. The connection stability is ensured, and the mounting is convenient and fast, greatly improving the assembly efficiency and ensuring the waterproof grade.

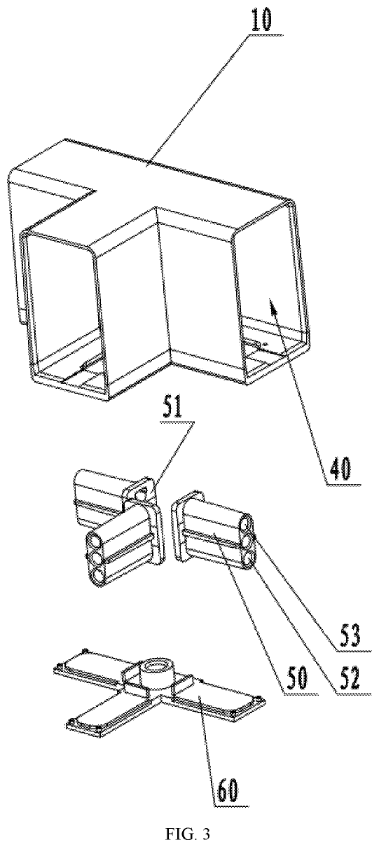

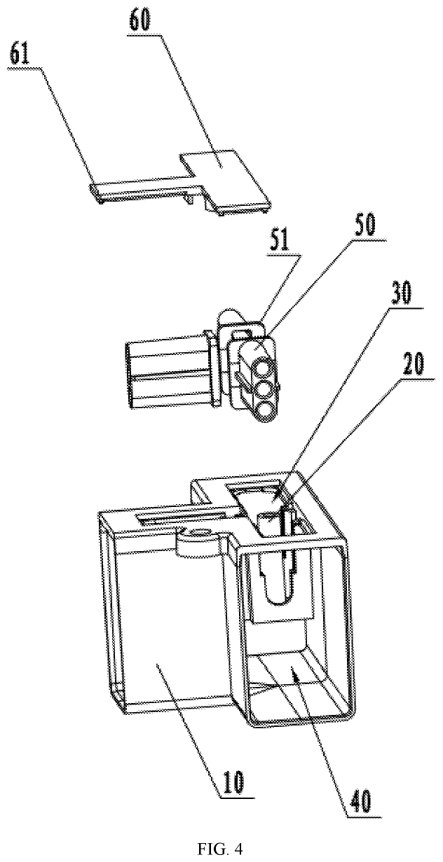

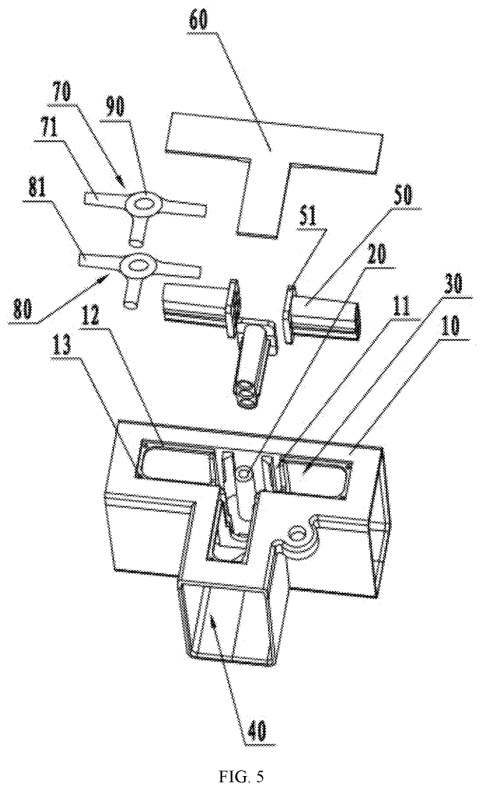

Further, in Embodiment 1 of this disclosure, as shown in FIG. 3, FIG. 4, and FIG. 5, a limiting block 51 is disposed at an end portion on an inner side of the insertion connector 50, the insertion structure is an insertion slot 11, and the limiting block 51 is inserted into the insertion slot 11 through the window 30 from the outside to the inside. Certainly, on the contrary, a limiting slot is formed at an end portion on an inner side of the insertion connector 50, the insertion structure is an insertion block, and the limiting slot is inserted into the insertion block through the window 30 from the outside to the inside.

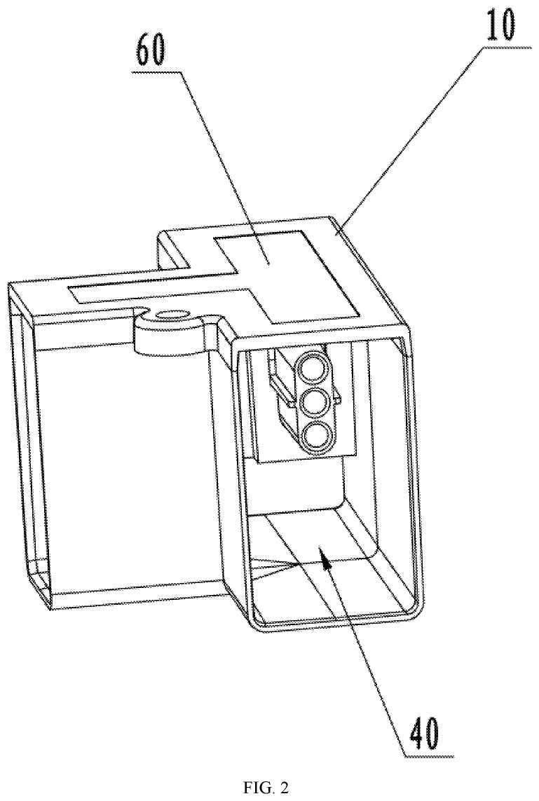

Further, in Embodiment 1 to Embodiment 6 of this disclosure, as shown in FIG. 2, FIG. 4, FIG. 6, FIG. 7, FIG. 8, FIG. 9, and FIG. 10, a plurality of positive conductive slots 52 and negative conductive slots 53 are formed in the insertion connectors 50. The negative conductive heads 81 are inserted into the negative conductive slots 53, and the positive conductive heads 71 are inserted into the positive conductive slots 52.

Further, in Embodiment 1 of this disclosure, as shown in FIG. 4 and FIG. 5, a snap structure for connecting the quick connector housing and the window cover in a snap manner is formed between the end surface of the quick connector housing 10 at an outer edge of the window 30 and the window cover 60. Specifically, a step 12 is disposed on the end surface of the quick connector housing 10, snap holes 13 are formed on the step, and snap columns 61 are formed on a bottom surface of the window cover 60.

Although this disclosure has been described in detail with reference to the foregoing embodiments, it will be apparent to those skilled in the art, through this disclosure, that various changes or modifications may be made to this disclosure without departing from the principles and spirit of this disclosure as limited by the appended claims. Therefore, the detailed description of the embodiments of this disclosure is provided merely for explanatory purposes and is not intended to limit this disclosure. The scope of protection is limited by the content of the claims.

What is claimed is:

1. A conductive quick connector structure, comprising a quick connector body, wherein the quick connector body comprises a quick connector housing (10), at least two quick connecting channels are integrally formed in the quick connector housing (10), all the quick connecting channels intersect within the quick connector housing (10) to form an intersection region, an insertion structure for inserting an insertion connector (50) is integrally formed on one side of the intersection region facing each quick connecting channel, and a positioning column (20) for sleeving a positive conductive component (70) and a negative conductive component (80) is integrally formed in the intersection region; a window (30) is formed on an end surface on one side of the quick connector housing (10) perpendicular to the positioning column (20), and the window (30) exposes at least a part of the quick connecting channel to sleeve the insertion connector (50) into the quick connecting channel from the outside to the inside; and a window cover (60) covers the window (30).

2. The conductive quick connector structure according to claim 1, further comprising a plurality of insertion connectors (50), wherein a number of the insertion connectors (50) is consistent with a number of the quick connecting channels.

3. The conductive quick connector structure according to claim 2, wherein a limiting block (51) is disposed at an end portion on an inner side of the insertion connector (50), the insertion structure is an insertion slot (11), and the limiting block (51) is inserted into the insertion slot (11) through the window (30) from the outside to the inside.

4. The conductive quick connector structure according to claim 2, wherein a limiting slot is formed at an end portion on an inner side of the insertion connector (50), the insertion structure is an insertion block, and the limiting slot is inserted into the insertion block through the window (30) from the outside to the inside.

5. The conductive quick connector structure according to claim 2, further comprising the positive conductive component (70) and the negative conductive component (80), wherein the positive conductive component (70) comprises a plurality of positive conductive heads (71), the negative conductive component (80) comprises a plurality of negative conductive heads (81), a number of the positive conductive heads (71) is consistent with that of the negative conductive heads (81), the number is consistent with the number of the insertion connectors (50), and at least the positive conductive head (71) and the negative conductive head (81) are disposed in each insertion connector (50).

6. The conductive quick connector structure according to claim 5, wherein a plurality of positive conductive slots (52) and negative conductive slots (53) are formed in the insertion connectors (50), the negative conductive heads (81) are inserted into the negative conductive slots (53), and the positive conductive heads (71) are inserted into the positive conductive slots (52).

7. The conductive quick connector structure according to claim 5, wherein a positioning sleeve (90) is disposed on each of the positive conductive component (70) and the negative conductive component (80), and the positioning sleeve (90) is sleeved on the positioning column (20).

8. The conductive quick connector structure according to claim 1, wherein a snap structure for connecting the quick connector housing and the window cover in a snap manner is formed between the end surface of the quick connector housing (10) at an outer edge of the window (30) and the window cover (60).

9. The conductive quick connector structure according to claim 1, wherein the quick connecting channels are quick connecting slots (40) integrally formed in the quick connector housing (10), and a quick connecting port is formed at one outward end of each quick connecting slot (40).

10. The conductive quick connector structure according to claim 9, wherein there are two, three, or four quick connecting slots (40) and quick connecting ports, and a shape of the quick connector housing (10) comprises a linear structure, a right-angled structure, a three-way structure, or a cross-shaped structure.
